(19) United States
(12) Patent Application Publication
(10) Pub. No.: US 2006/0225781 A1
(43) Pub. Date: Oct. 12, 2006

(54) Portable solar panel with attachment points

(76) Inventor: Steve Locher, Lafayette, CA (US)

Correspondence Address: Tue Nguyen, 496 Olive Ave., Fremont, CA, 94539, US

(21) Appl. No.: 11/397,255

(22) Filed: Apr. 3, 2006

Related U.S. Application Data
(60) Provisional application No. 60/669,230, filed on Apr. 7, 2005.
(60) Provisional application No. 60/669,229, filed on Apr. 7, 2005.
(60) Provisional application No. 60/669,228, filed on Apr. 7, 2005.
(60) Provisional application No. 60/669,227, filed on Apr. 7, 2005.
(60) Provisional application No. 60/669,226, filed on Apr. 7, 2005.
(60) Provisional application No. 60/669,150, filed on Apr. 7, 2005.
(60) Provisional application No. 60/681,658, filed on May 16, 2005.

(51) Int. Cl. H02N 6/00

(52) U.S. Cl. 136/245

(57) ABSTRACT

The present invention discloses a portable solar tarp or a field portable battery charger employing a solar tarp, utilizing flexible solar panels, solar fabric, or solar film. Around the perimeter of the solar tarp is a series of attachment points for straps. The attachment points can be grommets, loops, buckles, hooks, buttons, or grab loops and lines, and to which connected various straps (webbing, line, cord, or cable). The present invention further discloses a versatile, adjustable strapping system utilizing straps, buckles, and hooks. The present invention strapping system can attach almost any object to nearly any other object, such as back packs, luggage, vehicles, boats, permanent and portable shelters and buildings, mechanical equipment, and natural objects such as trees, rocks. The solar panel according to the present invention can have the photovoltaic cells wired individually, or in a single line, because when parts of the photovoltaic system is subjected to shade, or if due to space constraint, parts of the photovoltaic system is covered or folded away, the remaining photovoltaic cells with useable energy are still able to function at peak capacity, since the covered cells will not become an energy drain upon the remaining cells. Further, the photovoltaic system is able to harness all available energy, regardless of the required or desired voltage and/or amperage for the system, thus converting any and all available energy into a useable current to either recharge batteries, or power a load.

This application claims priority from U.S. provisional applications Ser. No. 60/669,230 filed Apr. 7, 2005, entitled “Photovoltaic cells and modules wiring”; Ser. No. 60/669,229 filed Apr. 7, 2005, entitled “Strapping system for photovoltaic cells”; Ser. No. 60/669,228 filed Apr. 7, 2005, entitled “Backpack strapping system for photovoltaic cells”; Ser. No. 60/669,227 filed Apr. 7, 2005, entitled “Vehicle strapping system for photovoltaic cells”; Ser. No. 60/669,226 filed Apr. 7, 2005, entitled “Tent strapping system for photovoltaic cells”; Ser. No. 60/669,150 filed Apr. 7, 2005, entitled “Field portable solar battery charger with backpack and vehicle strapping system”; and Ser. No. 60/681,658 filed May 16, 2005, entitled “Battery Multi-Interface Unit”; which are incorporated herein by reference.

### FIELD OF THE INVENTION

The present invention relates generally to portable solar panels and, more particularly, to a method and apparatus of a portable solar panel or a field portable solar battery charger.

### BACKGROUND OF THE INVENTION

Solar power is one of the clean and renewable sources of energy (the others being wind, geothermal steam, biomass, and hydroelectric) that have mass market appeal. Solar power uses energy from the sun to provide passive heating, lighting, hot water, and active production of electricity through photovoltaic solar cells. Photovoltaics are the most promising of active solar power which directly convert sunlight into electricity. However, photovoltaics are very expensive, in terms of high production cost and low efficiency.

Significant works have been done to improve the efficiency of the photovoltaic array. One of the earliest improvements is the addition of a battery. Without the battery, the photovoltaic array can supply electrical power directly to a load. The major drawback of this configuration is the uneven distribution of solar energy: during daylight operation, the photovoltaic array can produce excess power while during night time or periods of reduced sun light, there is no power supplied from the photovoltaic array. With the addition of a battery, the battery can be charged by the photovoltaic array during periods of excessive solar radiation, e.g. daylight, and the energy stored in the battery can then be used to supply electrical power during nighttime. Thus a photovoltaic system today almost inevitably includes a battery component.

Single solar cell normally produces voltage and current much less than the typical requirement of a load. A photovoltaic cell typically provides 0.2-1.4 V and 0.1-5 A, depending on the photovoltaic cell and its operating conditions, e.g. direct sun light, cloudy, etc., while the load might need about 5-48 V, 0.1-20 A. Thus a number of photovoltaic cells are arranged in series to provide the needed voltage requirement, and arranged in parallel to provide the needed current requirement. These arrangements are critical since if there is a weak cell in the formation, the voltage or current will drop and the solar cell array will not be functioning properly. Thus for example, it is normal to see a photovoltaic array arranged for 17 V to provide 12 V to a battery. The additional 5 V provides a safety margin for the variation in solar cell manufacturing and solar cell operation, e.g. reduced sun light conditions.

Many solar panels designed are adapted to permanent roof mount and for water heating. Such panels are cumbersome, requiring complicated mounting structure and assembly.

### SUMMARY OF THE INVENTION

The present invention discloses a portable solar panel and a portable battery charger utilizing a solar panel such as a flexible solar tarp. Around the perimeter of the solar tarp is a series of attachment points for straps, such as grommets, loops, buckles, hooks, buttons, or grab loops and lines, to which connected various straps (webbing, line, cord, or cable) for attaching to any object or structure. The present invention further discloses a versatile, adjustable strapping system utilizing straps, buckles, and hooks. The present invention strapping system can attach almost any object to nearly any other object, such as back packs, luggage, vehicles, boats, permanent and portable shelters and buildings, mechanical equipment, and natural objects such as trees, rocks.

On flexible panel systems, such as a single cell, or a tarp/fabric style solar array, the attachment points can consist of various ring devices (including D, O, Square, Rectangular, Loop), grommets, webbing, rope, wire, or chain loops, grab lines, buttons, “suspender” buttons, or any similar devices. For rigid panels, the attachment points can include the above listed, and also the eye bolts, rings, handles, holes, cleats, and suction cups. The strapping system can also comprise a plurality of straps or strap attachments, such as webbing, rope, wire, or chain out of synthetic (nylon, polyester, rubber, or fabric) or metal materials, in a variety of widths, thicknesses, and configurations. The straps or strap attachments may be attached to the solar panel or array using a variety of buckles, snaps, hooks, or buttons. The strapping system can also comprise devices for adjusting the length and tightness of the strap, such as adjustable buckles, tension locks, line tensioners, cleats, cam buckles, cord locks, adjustable eyebolts, and adjustable bolts. The attachment hooks can be used to attach the solar cell or array to any object or structure, man made or natural, and being in the form of: J hooks, S hooks, gutter hooks, flat hooks, snap links, or other equipment specific devices.

To attach to a backpack, a strap with a buckle on each end is run underneath the shoulder straps, or load lifter straps, of the backpack, and clipped into one, or two, attachment points on one end of the solar tarp. To attach to a vehicle, a set of straps with a buckle on one end (to attach to the solar tarp) and a hook on the other (to attach to the vehicle) is utilized.

The present invention further discloses a battery multi-interface unit to interface with the portable solar panel, which is an electronic device which has one or more battery interface capabilities, AC/DC current conversions and outlets, and input connectors for the purpose of charging batteries, transferring power from one battery to another, and operating electric devices with AC/DC currents. In addition, interfaces for electric current input from solar, wind, generator, vehicle, or other energy sources may be provided for recharging any voltage battery.

The present invention portable solar panel further discloses a method to improve the efficiency of a solar panel, especially in low light or partial shading conditions. Each solar cell or module, or a line of solar cells or modules are re-wired and the new set of wires are brought out of the solar panel, connecting to an efficiency improvement circuit before powering a load or charging a battery. The efficiency improvement circuit can be a multiplexer circuit, a voltage booster, a current booster circuit or a maximum power point tracking circuit.

### BRIEF DESCRIPTION OF THE DRAWINGS

FIG. 1 shows a variety of attachment point devices on a solar panel.

FIG. 2 shows a variety of other attachment points on a solar panel.

FIG. 3 shows a variety of attachment point devices on a rigid solar panel.

FIG. 4 shows an exemplary embodiment of the present invention solar panel with attachment points.

FIG. 5 shows an embodiment of the present invention method for preparing a field portable solar panel battery charger.

FIG. 6 shows a prior art solar panel where all the solar cells are wired in series.

FIG. 7 shows a prior art solar panel where the solar modules are wired in series pairs and the module pairs are wired in parallel.

FIG. 8 shows an embodiment of the present invention solar cell wiring system where the solar modules are wired individually.

FIG. 9 shows an embodiment of the present invention solar cell wiring system where the solar modules are wired linely, i.e. the solar modules are wired to form lines.

FIG. 10 shows a configuration of the present invention strapping system for solar panel.

FIGS. 11 and 12 show the back and front views of an exemplary embodiment of the present invention solar panel backpack strapping system having the solar panel on the backside of the backpack.

FIGS. 13 and 14 show the back and front views of an exemplary embodiment of the present invention solar panel backpack strapping system having the solar panel on the side of the backpack.

FIG. 15 shows the attachment of a solar panel on the roof of a vehicle.

FIG. 16 shows the attachment of a solar panel on the trunk and hood of a vehicle.

FIG. 17 shows different views of an exemplary embodiment of the present invention solar panel with attachment points fastened to a backpack.

FIGS. 18 and 19 show different configurations an exemplary embodiment of the present invention solar panel with attachment points fastened to a vehicle.

FIG. 20 shows an embodiment of the present invention solar panel tent strapping system with various attachment straps.

### DETAILED DESCRIPTION OF THE INVENTION

The present invention discloses a method and an apparatus for a universal mounting strapping system, with a preferred application to solar panel systems such as a portable solar panel or a field portable battery charger utilizing a solar panel such as a solar tarp. The disclosed portable solar panel system comprises an efficiency solar panel or array with a plurality of attachment points, together with a versatile, adjustable strapping system, capable of attaching to nearly any object, such as back packs, luggage, vehicles, boats, permanent and portable shelters and buildings, mechanical equipment, and also natural objects such as trees, and rocks.

The solar panel according to the present invention can be rigid or flexible with different attachment units designed for rigid or flexible connections. When the solar panel is to be used, the strap assembly allows the panel to be secured to a support structure. The flexible solar panel has various advantages, for example, it can be folded or rolled, allowing the solar panel to be easily transported and stored. The advantage of this is that the solar panel may be relatively easily manhandled and/or folded up for stowage. The solar tarp according to the present invention can be a flexible solar panels, solar fabric, or solar film, and can be of any shape or size, depending upon the end use application.

The strapping assembly on the solar panel comprises a plurality of attachment points on the solar panel, a plurality of straps and strap attachments, together with devices for adjusting the length and tightness of the strap. The strap assembly can include a plurality of straps, extending from the panel edges, constructed and arranged to secure the solar panel in an extended configuration. The strap assembly may include length adjustable straps such as a latch, a catch, and a buckle coupled with the strap. The buckle can be a common spring loaded buckle mating with the strap. The material and construction of either the strap or the buckle are designed to suit the requirements of a user or manufacturer. For example, a wire may be substituted for a strap, and various length adjustment devices may be substituted for the buckle, such as a double ring arrangement. The strap can also include a grasping loop to facilitate the tie-down of the panel system. The catch can be any suitable clasp or hook, preferably with a keeper. Many common snap hooks have been found to work well. The straps can be removeable or permanently attached to the solar panels by sewing, bolts, or any other attachment method during the manufacturing processes.

Further, an embodiment according to the present disclosure is a solar panel having removable, re-positionable attachable strap assembly. The strap assembly comprises a plurality of straps having a releasable fastener portion affixed to one end of the strap, with a plurality of mating fastener portions affixed to the solar panel. The fasteners are arranged to be surrounding the solar panel, with at least one mating fastener portion positioned at the bottom, top, and sides of the panel. The ends of the attachable straps can be re-positioned laterally. The strap lengths can be adjusted with conventional means so that it fits a large range of structure sizes and types. The straps might be fitted through slits in the panel, or it might be held in place by a fastener such as a loop, adhesive, or, by a hook-and-loop fastener system.

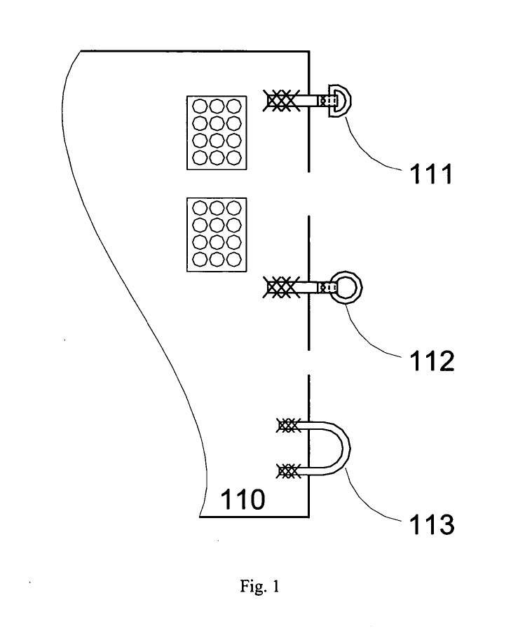

FIG. 1 shows a configuration of the present invention strapping system for solar panel. The solar panel 100 comprises a plurality of solar cells or modules arranged on the surface of the solar panel. The solar panel can be any conventional solar panel, or an improved solar panel. The solar panel further comprises a plurality of attachment points 101 positioned on the solar panel. The attachment points are preferably positioned at the surrounding edge of the solar panel, they could be positioned practically anywhere within the solar panel, or even extended from the solar panel. The attachment points 101 shown are grommets, securely fastened to the solar panel around the edge of the solar panel. Thus in one embodiment, the invention is a solar panel having a plurality of attachment points. In another embodiment, the invention further comprises a plurality of strapping systems, such as a rope 102, tightening units (or a tensioner) 103 connected to the attachment point by a strapping means 104. Only one tensioner 103 is needed for tightening the solar panel, but in practice, 2 tensioners, each near the attachment points on the solar panel, can facilitate the securing work. A surround rope 102 is shown, but other means can be used, such as a belt, or a cable. Further, the strapping does not have to loop from one attachment point to another attachment point, but a separate strapping can be connected to each attachment points.

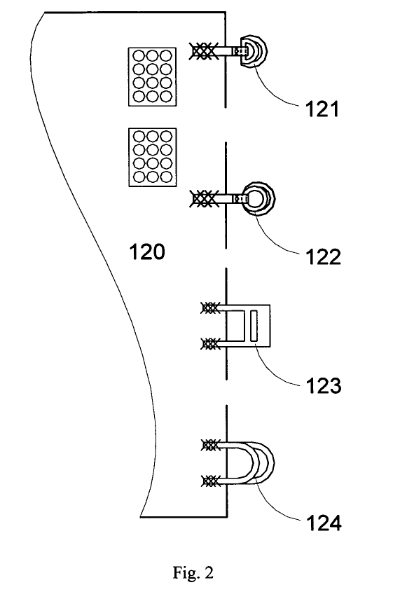

The attachment points can comprise a plurality of D-rings, O-rings, or web rings, spaced apart vertically and horizontally along the edge of the solar panel. FIG. 2 shows a variety of attachment point devices on a solar panel 110. The attachment points can be a D-ring 111, an O-ring 112, or a web ring 113, attached to the edge of the solar panel by an attachment means, for example, by sewing onto the solar panel as shown. The rings and the connections can be made of plastic, metal, textile or rope.

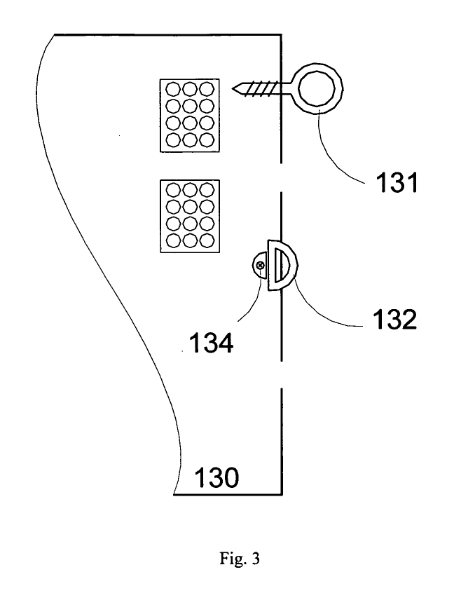

Spring-actuated locking hooks could be used to the end of the straps for securing the straps to the attachment points. It is to be understood that the spring-actuated locking hook is just an example of the present invention. Other adjustable removable strap attachments could also be made by using a second ring in the same webbing loop as each of the rings. FIG. 3 shows a variety of removable attachment points on a solar panel 120, such as a double D-ring 121, a double O-ring 122, a locking device 123, and a double web-ring 124.

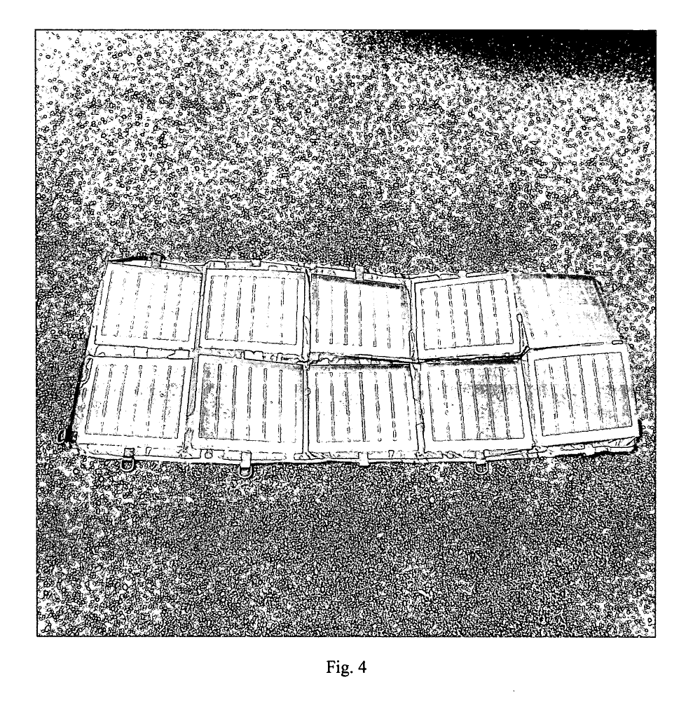

For rigid solar panel, the attachment points can further comprises other devices such as eye bolt or screw-on D-ring. FIG. 4 shows a rigid solar panel 130 with an eye bolt 131 attachment and a screw-on D-ring attachment having a screw 134 to fasten the D-ring 132 onto the solar panel.

The strap assembly can include restraining straps integral with the solar panel. For example, the restraining straps could be a web, formed integrally with the panel. The straps could be secured with adhesive or other fastening devices to the panel. An advantage of this construction is that lightweight material may be employed for the panel and material with relatively high tensile strength properties. Therefore, overall, the strap assembly may be very light, especially for flexible solar panel system. The restraining straps may be a lateral series of mutually spaced straps, extending along the edges of the panel, in a lateral or longitudinal direction.

In one embodiment, each strap includes a fastener adapted to be secured to the support structure. Each strap may include a tensioner device such as a hook, and the strap base preferably including a corresponding engagement means. The strap assembly may include quick attach clips to fasten the free ends of the fastening strap to the support structure, preferably permit the ends of the strap to be pulled, to shorten the length of strap between the two quick attach clips. This can tighten the solar panel around the support structure.

This invention provides a solar panel system with a strapping assembly for covering a portion of the exterior surface of a support structure, such as a tree, a vehicle body, or a building, which is quickly and easily installable or removable, and which is readily adjustable to accommodate for any distortion of the shape or dimensions of the support structure. Further, the utilization of the strap assembly in the solar panel system offers significant advantages by providing a larger adjustable connecting arrangement, a quick attachment and release, and which have a longer useful life, easily replaceable parts. The strap assembly can include holes, surrounded by grommets, positioned along the edges and sides of the solar panel, preferably positioned about one-half to two inches from the edge.

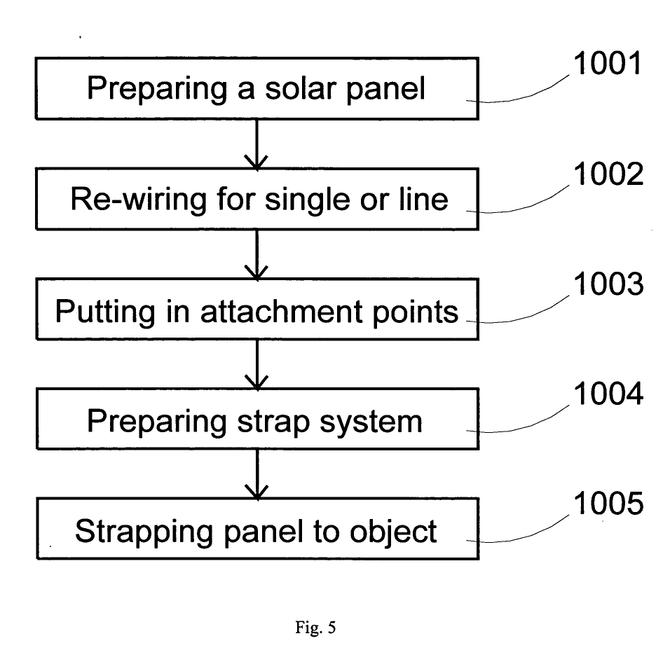

FIG. 5 shows an exemplary embodiment of the present invention solar panel with attachment points. The solar panel is a flexible solar panel comprising 14 solar modules with 10 D-rings sewn on the outer edge of the flexible support.

The invention also features a method of making solar panel with attachment points or refurbishing existing solar panel attachment points by preparing the solar panel and attaching a plurality of attachment to the solar panel. The method further comprises the step of preparing a strap assembly; and then using the strap assembly to secure the solar panel to a support structure.

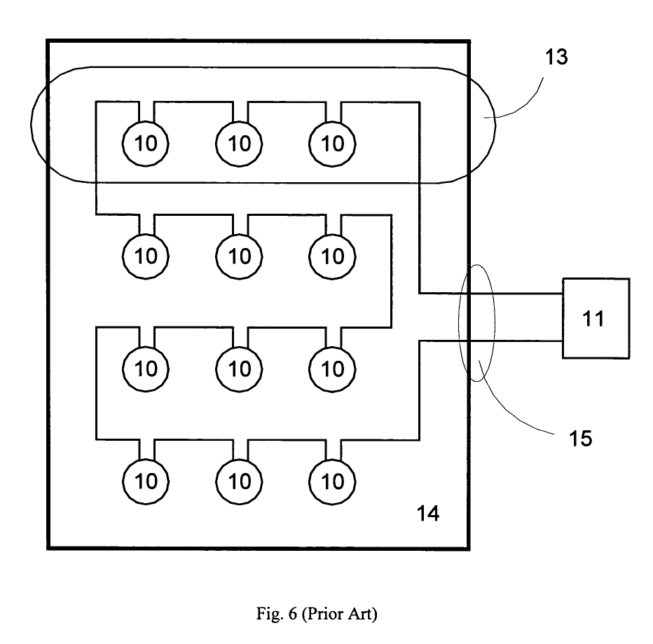

FIG. 6 shows an embodiment of the steps for the method of making a portable solar panel according to the present invention. The first step 1001 is the preparation of a solar panel. This may be as complex as the design and fabricate a solar panel, but also can be as simple as buying an existing solar panel meeting the desired specifications. After having the desired solar panel, the next step 1002 is to re-wire the solar cells or modules in the solar panel to be connected individually or connected in lines. In other words, instead of bring out only a pair of output connection of conventional solar panel, the re-wiring step brings out n pairs of output connection with n is the number of solar cells or modules in the event of individual re-wired, or n/m pairs of output connection with n is the number of solar cells or modules and m is the number of solar cell/module lines in the event of re-wiring into m lines. Step 1002 can be optional, and is designed to improve the efficiency of the solar circuits. The next step 1003 is putting into the solar panel a plurality of attachment points. These attachment points allow the versatile connection to the solar panel. With the attachment points, the solar panel can be attached to practically any object. The next step 1004 is to prepare a number of strap systems. And the last step 1005 is to attaching the strap systems to the solar panel and the object, such as a backpack or a vehicle.

As shown in step 1002, the connection of the cells or modules in the solar panel can be re-wired to improve the efficiency of a solar panel. Each solar cell/module connection, or a line of solar cells/modules connection, is brought out of the solar panel, to be connected to an efficiency improvement circuit before powering a load or charging a battery.

In various applications, the best configuration for integration of the solar tarp to the structure or object might require folding the solar tarp. Thus the present invention further discloses a re-wiring improvement to the solar panel to prevent loss of solar efficiency under folded or partial solar tarp configuration.

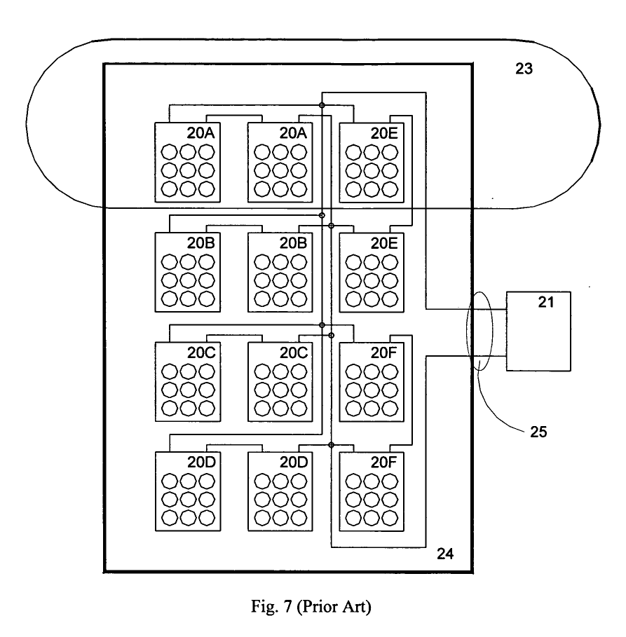

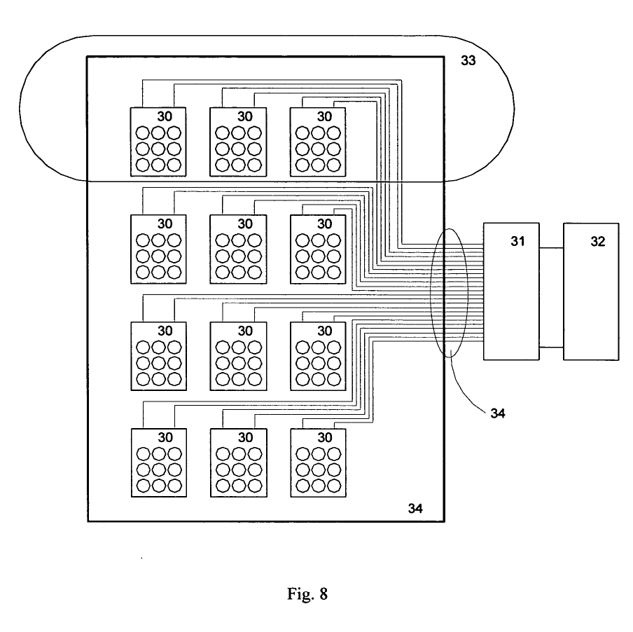

Typically, for minimizing connection, solar cells or modules in a solar panel are typically wired in series, parallel or any series/parallel combination, with usually with two output wires. FIG. 7 shows a prior art solar panel 14 comprising a plurality of solar cells 10. These solar cells are connected in series and the output of this solar panel 14 is a 2-wire connection 15, to power a load or to charge a battery 11. Under this wiring scheme, if a shadow 13 forms over a portion of the solar panel, the power efficiency of the whole panel would be affected since all cells are inter-dependent to all others. FIG. 8 shows another prior art solar panel 24 comprising a plurality of solar modules 20. These solar modules 20 are connected is pairs 20A to 20F, i.e. two modules are connected in series and all pairs connected in parallel. Again the output of this panel is a 2-wire connection 25 to power a load or to charge a battery 21. Similarly, if a shadow or a cloud 23 is to form over a portion of the solar panel, the power efficiency of the whole panel would be affected since all modules are inter-dependent to all others.

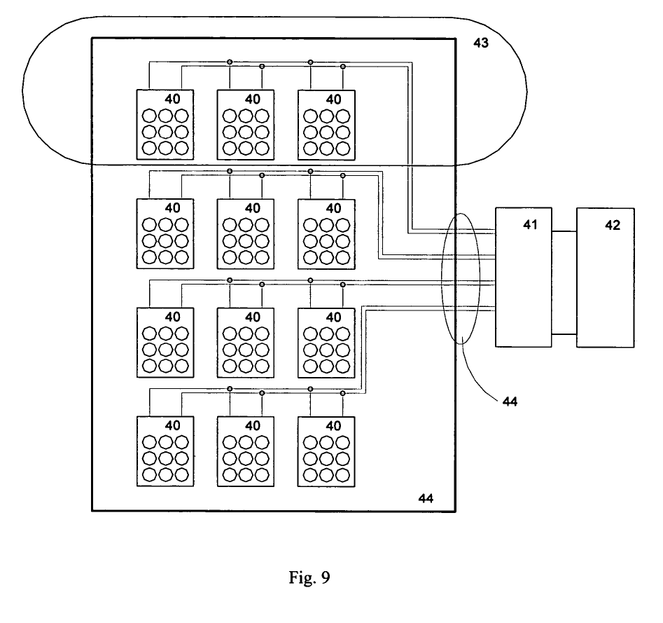

FIG. 9 shows an embodiment of the present invention solar module wiring system where all solar modules are wired individually. The solar panel 34 comprises a plurality of solar modules 30 and all the output connections of these modules are brought out of solar panel at connection 35 to be connected to an efficiency improvement circuit 31 before powering a load 32 or charging a battery. The efficiency circuit 31 can be automatically configured to take into account all individual conditions of each solar module and take action accordingly to ensure the optimum power output. For example, if a shadow or cloud 33 forms over a few of the solar modules, the efficiency circuit 35 can ensure the contribution of shaded modules as well as the contribution of fully exposed modules.

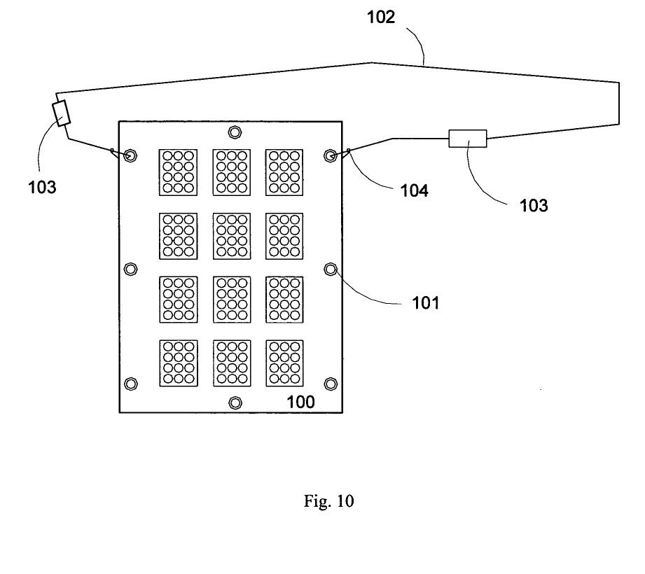

FIG. 10 shows an embodiment of the present invention solar module wiring system where the solar modules are wired in single line (linely). The solar panel 44 comprises a plurality of solar modules 40 where these modules are wired into lines. All the output connections of these module lines are brought out of solar panel at connection 45 to be connected to an efficiency improvement circuit 41 before powering a load 42 or charging a battery. The efficiency circuit 41 can be automatically configured to take into account all line conditions of each solar module and take action accordingly to ensure the optimum power output. For example, if a shadow or cloud 43 forms over a line of the solar modules, the efficiency circuit 45 can ensure the contribution of shaded line as well as the contribution of fully exposed lines.

The photovoltaic (PV) cells can be flexible or rigid, and by wiring photovoltaic cells or modules individually, or linely, several benefits can be realized. First, when the PV system is subjected to shade, if only one or more panels becomes shaded, the remaining panels with useable energy are still able to function at peak capacity, since the shaded panels will not become an energy drain upon the remaining panels. This shaded condition could occur when, for example, tree or cloud shade moves over the PV system, or if a row of panels becomes covered or folded away. Secondly, when wired singly, or linely, the PV system is able to harness any available energy, regardless of the required or desired voltage and/or amperage for the system, thus converting any and all available energy into a useable current to either recharge batteries, or run power directly to requirements. This method is unique from any existing PV systems in that the PV cells which comprise the module are not wired in series, parallel, or series/parallel combination. Further, since maximum power point control is performed for each cell or module, the power unbalance can be minimized.

The re-wiring of the solar panel provides control over individuals or over lines of solar cell/module, thus the solar cells/modules are electrically detachably attached to the solar panels, and consequently, from a circuit stand point, damaged or non-performing unit solar cells/modules can be addressed from the load site.

The re-wiring of the solar panel also provides an improvement over prior art solar panel employing bypass diode. Bypass diodes are typically built in the solar cell/module and function to effectively electrically remove the solar cell/module out of the solar panel when this particular cell/module power output drops below the operating voltage. In contrast, the solar panel with the re-wiring has control over each solar cell/module or a line of solar cell/module to determine the contribution of the particular cell/module. Thus in the partially shaded condition, the solar cell/module output power is still contribute to the solar panel, since the output voltage or current of the solar cell/module can be controlled, for example, boosted to the operating condition of the solar panel.

The present invention solar tarp with a series of attachment points for straps around the perimeter can be applied to backpacks, vehicles, or tents as portable power source. Another possible application is portable power ice chests for the hunting, camping, fishing, marine, medical, and home emergency/survival markets, where the ice chest has a portable solar panels as a power source.

Backpack is one of the most convenient personal luggage carriers, ranging from students, travelers, to soldiers with various ways in which the backpack is worn such as high between the shoulder blades or low at the small of the back. Though with significant modifications and improvements over the years, the fundamentals of backpacks remain the same: a back with a plurality of straps to be carried over the shoulder or back. In the context of the present disclosure, backpack includes any bag that a person can carry over the shoulder or back, such as a bookbag, knapsack, haversack, rucksack or Courrier bags.

The present invention discloses an integration of a solar panel to a backpack for portable power source. The strapping system according to the present invention is designed to attach any rigid or flexible photovoltaic cell, individually or in an array, to any style or size of backpack, civilian, government, or military. The system works in conjunction with the desired photovoltaic system having attachment points (hooks, grommets, buckles, buttons, eyelets, etc.) for straps (webbing, rope, cord, cable, chain, etc. with buckles, buttons, hooks, etc.) in two different applications: on the backside of the backpack, and on the side of the backpack. When attached to the backside of the backpack, one strap with a buckle (side release, snap link, etc.) on each end is connected to one end of the solar device and run underneath the top portion of the shoulder straps, or load lifter straps, and reconnected into one, or two, attachment points on one end of the solar tarp. Then, one or more straps, also with buckles on each end, are connected to one side of the solar device and run around the back band of the backpack, and reattached to the solar device on the opposite side to prevent bouncing or flapping of the device, and to hold it tightly to the backpack. When the straps are tightened appropriately, the solar device is securely attached to the backpack. To adjust for the height of the backpack, one or more rows of photovoltaic cells/solar panels can be folded up to match the height of the backpack, or folded sideways to match the width of the backpack.

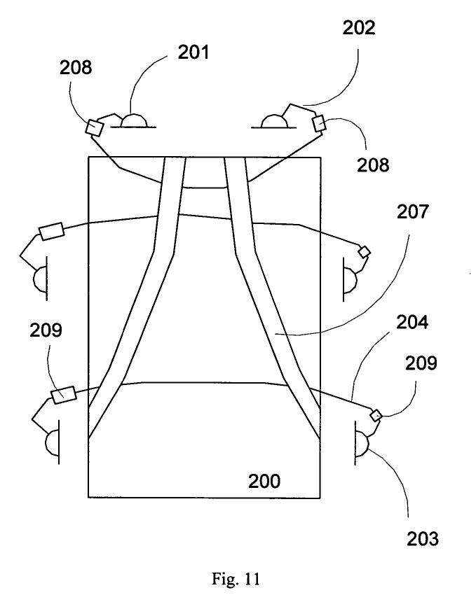

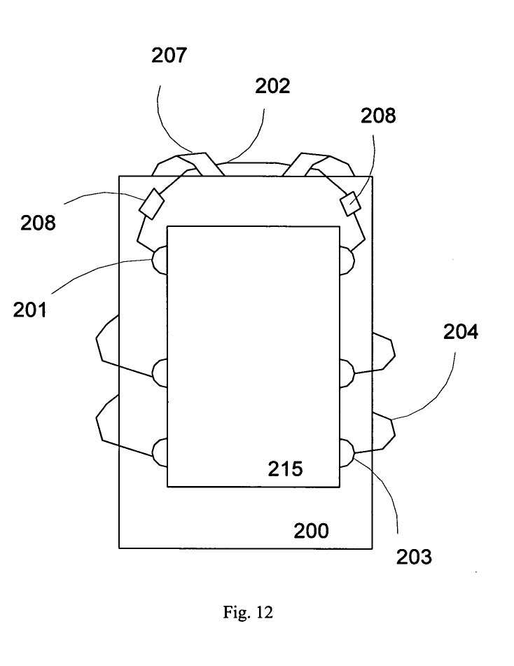

FIGS. 11 and 12 show the front view and back view respectively of an embodiment of the present invention backpack strapping solar panel. FIG. 7 shows the front view of the backpack 200, the side to touch the back of the person, showing with two shoulder straps 207. The solar panel 215 is attached at the backside of the backpack, with its various attachment points 201 and 203 are shown in both figures. Attachment point 201 is one of the top side attachment points, connected to the top side of the solar panel, and attachment point 203 is one of the bottom side attachment points, connected to the bottom side of the solar panel. The attachment points are shown to be on the side of the solar panel, but they could be at the top side or at the bottom side as well. One strap 202 is connected to a top side attachment point 201 of the solar panel, runs underneath the top portion of the shoulder straps 207 and re-connected to another top side attachment point. Two tensioners 208 are served to tighten the strap. Functionally speaking, one tensioner is adequate, but two tensioners near the edge of the backpack at the hand reach could facilitate greatly the tightening action. Another strap 204 is connected to a bottom side attachment point 203 of the solar panel, run around the backpack, either underneath the shoulder straps, on top of the shoulder straps or outside of the shoulder straps, to connect to another bottom side attachment point. Two tensioners 209 are also provided to tighten the strap. The figures also show an optional third strap connecting to the middle side attachment points.

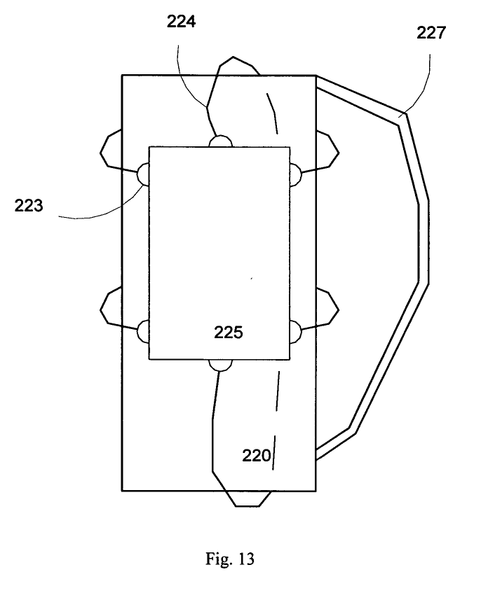

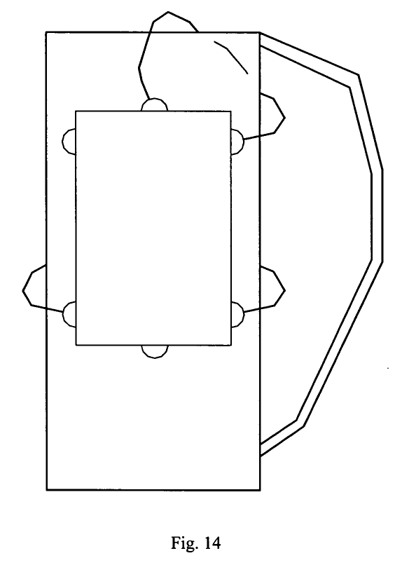

When attached to the side of a backpack, the first strap is run up to, or over and down, the top portion of the backpack, and secured to another strap or attachment point on the pack. Then one or more straps are run around the backpack as before to secure the solar device to the backpack. FIG. 13 shows an embodiment of side backpack strapping configuration. The solar panel 225 has side attachment points 223 and top/bottom attachment points. A couple of straps is connected to a side attachment point 223, runs around the backpack 220, under the shoulder straps 227, and re-connects at another side attachment point. Another strap 224 is running from the top attachment point, around the backpack and connects to a bottom attachment point. FIG. 14 shows a variation of side backpack strapping configuration where the top strap goes around and connects to one of the side attachment point. These configurations are just a few examples of many possible ways to attach the present invention backpack strapping solar panel system to a backpack.

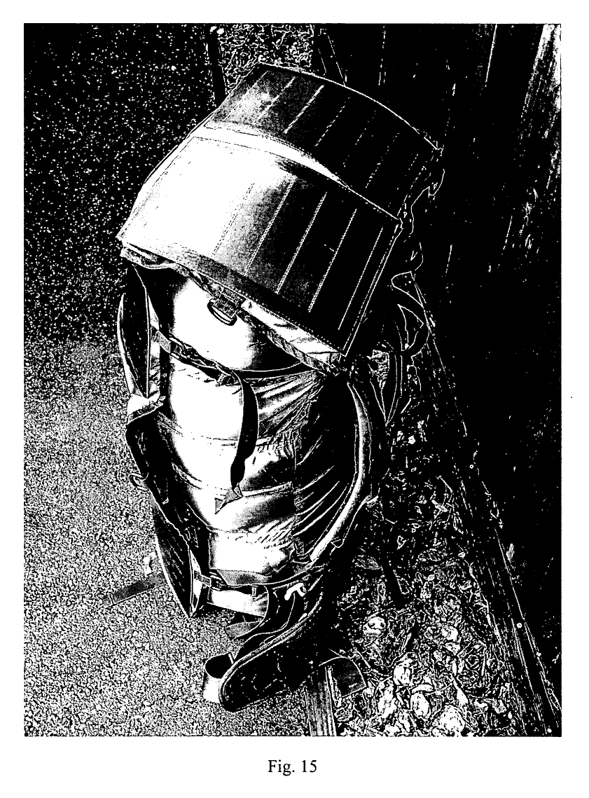

FIG. 15 show an actual configuration of the present invention backpack strapping solar panel system attached to a backpack, with the solar panel fastened to a backpack employing a plurality of locked hooks with tensioner devices.

The present invention also discloses an integration of a solar panel to a vehicle for portable power source. By attaching the straps with the loop or hook to the solar device, said solar device can be attached to the hood, roof, trunk, or front/side/back of a vehicle by placing the hook on a bumper, wheel well, spring, towing hook, hood edge, roof gutter, door jamb, etc., or by running the straps under the roof, through the doors. When this is done, using two or more straps appropriately tightened, the solar device is securely attached to the vehicle for all driving conditions.

To attach to a vehicle, a set of straps with a buckle on one end (to attach to the solar tarp) and a hook on the other (to attach to the vehicle) is utilized. The vehicle hooks (gutter hooks, S hooks, J hooks, or webbing loops) connect to the vehicle in a number of different ways depending upon the vehicle, and where it is being attached. For example, if attaching the solar tarp to the hood or trunk, the straps can be attached to the wheel wells, hood edge, or bumper with gutter hooks, to the towing hooks, windshield wipers, springs, or shocks with nylon loops or S/J hooks. If attaching to the roof of the vehicle, gutter hooks can be used on the rain gutters or the door frame, or the straps can simply be run through the door frames (from one side to the other) with the doors closing on the straps.

In one embodiment, each strap includes a fastener adapted to be secured to the vehicle. Each strap may include a tensioner device such as a hook, and the strap base preferably including a corresponding engagement means. The strap assembly may include quick attach clips to fasten the free ends of the fastening strap to the support structure, preferably permit the ends of the strap to be pulled, to shorten the length of strap between the two quick attach clips. This can tighten the solar panel around the vehicle.

This invention provides a solar panel system with a strapping assembly for covering a portion of the exterior surface of a vehicle, which is quickly and easily installable or removable, and which is readily adjustable to accommodate for any distortion of the shape or dimensions of the vehicle. Further, the utilization of the strap assembly in the solar panel system offers significant advantages by providing a larger adjustable connecting arrangement, a quick attachment and release, and which have a longer useful life, easily replaceable parts. The strap assembly can include holes, surrounded by grommets, positioned along the edges and sides of the solar panel, preferably positioned about one-half to two inches from the edge.

In the preferred embodiment, the solar panel has two attaching straps, one strap for the top and bottom of the panel and one strap for the sides of the panel. The straps are preferably of soft material in order to not damage the vehicle. The strapping system is designed for rapid and easy installation, application and storage, light-weight, compact and easy to transport, one size-fit-all to fit vehicles of various sizes and styles. The strapping system is also designed to easily positioned or removed without the use of tools.

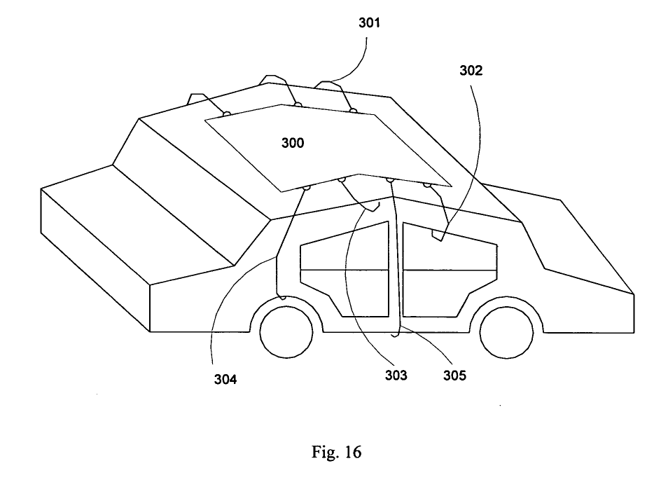

FIG. 16 shows the present invention vehicle solar panel strapping system attached to a roof of a vehicle. The solar panel comprises a plurality of attachment points to which straps can be connected and attached to the vehicle body. A strap 302 can go through an open door and emerges 301 through the other open door to connect to an opposite attachment point. Since the strap is thin and flexible, the doors can be close without any difficulty. Another strap 303 can hook to the roof gutter, or another strap 304 can hook to the wheel guard section. Other strap 305 can hook to the bottom frame of the vehicle, preferably in the area between the doors to allow for door opening and closing.

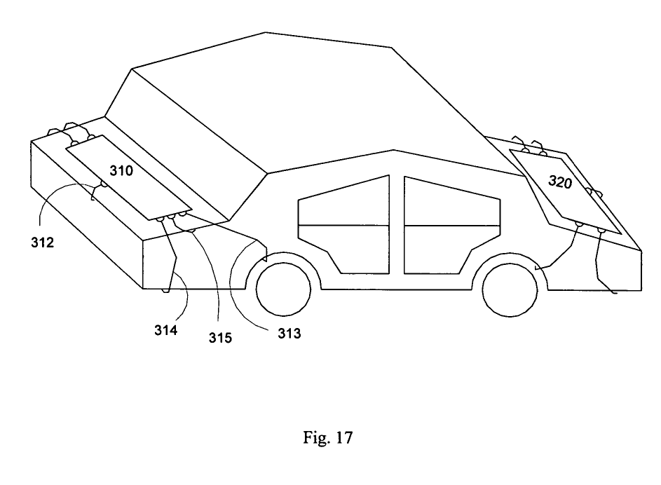

FIG. 17 shows the present invention vehicle solar panel strapping system attached to a hood 320 or a trunk 310 of a vehicle. A strap 314 can hook to the bottom frame, and another strap 313 can hook to the wheel guard section. Also a strap 315 can hook to the side trunk or a strap 312 can hook to the end trunk. By utilizing the trunk or the hood for attaching the solar panel, the straps do not prevent opening or closing of the trunk or hood.

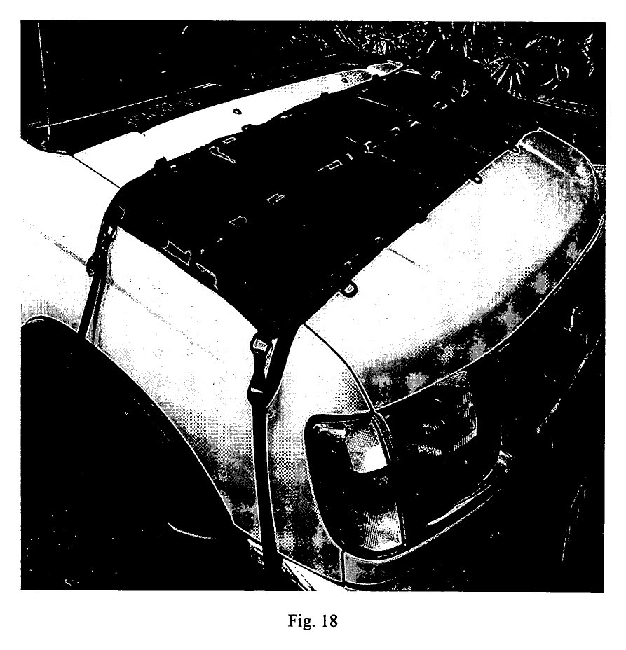

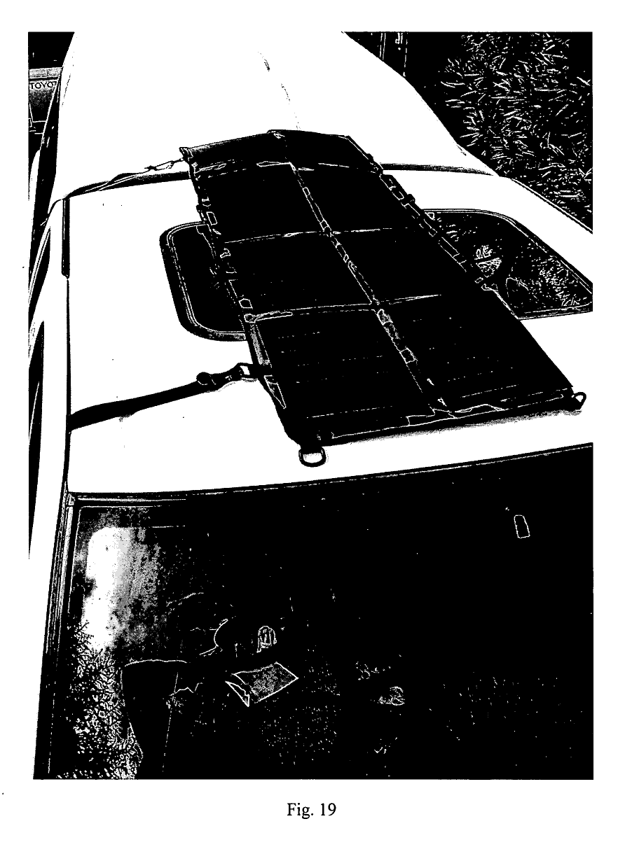

FIGS. 18 and 19 show the various actual installations of the present invention vehicle solar panel attachment system. FIG. 18 shows the installation of a solar panel on a vehicle hood with straps attaching to the wheel guard section and the front bottom bumper section. FIG. 19 shows the installation of a solar panel on a vehicle roof with a strap attaching through the door.

The present invention discloses an integration of a solar panel to a tent or a tent-like structure for portable power source. The system works in conjunction with the desired photovoltaic system having attachment points (hooks, grommets, buckles, buttons, eyelets, etc.) for straps (webbing, rope, cord, cable, etc.). The straps which are attached to the solar device are run down to attachment points on the tent, either buckles or loops, or can be run down to attachment points on the ground, such as stakes, anchor points, vehicles, natural objects (trees, rocks, etc.), or other possible anchors. When the straps are tightened appropriately, the solar device is securely attached to the structure in any conditions.

This invention provides the securement of solar panel to the fabrics and sheet materials used in tents. Since tents normally fabricated with marginal ties, straps, cords and loops sewn or permanently secured to the panel, the present invention trap assembly is designed with enough flexibility to accommodate various variations of the tent strap placements. The strap assembly is preferably a flexible strap to engage over a portion of a tent panel. The strap ends have male and female members adapted to have releasably locked engagement with the tent panel.

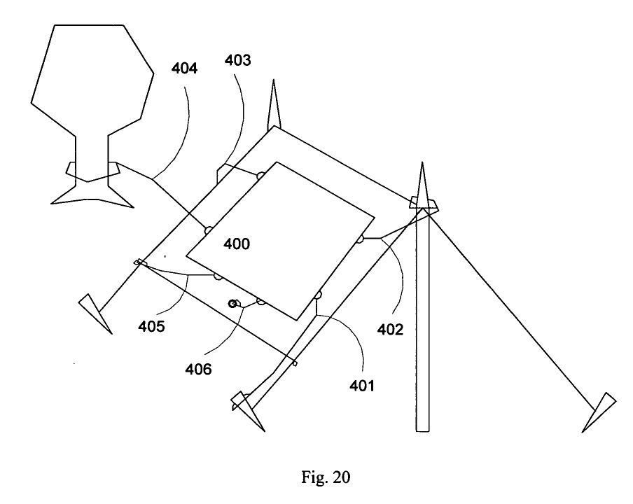

FIG. 20 shows an embodiment of the present invention tent solar panel strap system attached to a tent. The solar panel 400 has a plurality of attachment points surrounding the peripheral of the solar panel. A strap 401 attaches a solar panel attachment point to a tent anchor. Another strap 402 attaches a solar panel attachment point to a tent post. Another strap 403 attaches a solar panel attachment point to a tent flap. Another strap 404 attaches a solar panel attachment point to a nearby tree. Another strap 405 attaches a solar panel attachment point to a tent end web normally present at the corners of a tent flap. Another strap 406 attaches a solar panel attachment point to a temporary or permanent anchor device such as the grip clip, swift clip or interlocks from Sierra Designs.

The solar panel employed in present invention can comprise a solar panel efficiency improvement assembly. Each solar cell/module connection, or a line of solar cells/modules connection, is brought out of the solar panel, to be connected to an efficiency improvement circuit before powering a load or charging a battery. The typical optimum operating voltage of a solar cell element is between 0.7 to 1.4 V, and since a voltage of 3.3 or 5 V is usually needed to operate a load, the addition of an efficiency improvement circuit such as a booster circuit to each solar cell or to each line of solar cells can significantly improve the efficiency of the solar panel. The booster circuit is preferably low cost or high efficiency since a high cost or low efficiency would impact the cost effectiveness of the solar panel. The efficiency improvement circuit can also be a controlled multiplexer circuit, a booster circuit, or a maximum power point tracking circuit. The booster circuit is typically a voltage booster or a current booster circuit. Thus instead of the conventional 2 wire output for conventional solar panel, the wiring improvement solar panel provides 2n wire output for n cells or modules wiring individually, or n/m wire output for n cells or modules wiring in lines of m cells/modules per line.

The photovoltaic (PV) cells can be flexible or rigid, and by wiring photovoltaic cells or modules individually, or linely, several benefits can be realized. First, when the PV system is subjected to shade, if only one or more panels becomes shaded, the remaining panels with useable energy are still able to function at peak capacity, since the shaded panels will not become an energy drain upon the remaining panels. This shaded condition could occur when, for example, tree or cloud shade moves over the PV system, or if a row of panels becomes covered or folded away. Secondly, when wired singly, or linely, the PV system is able to harness any available energy, regardless of the required or desired voltage and/or amperage for the system, thus converting any and all available energy into a useable current to either recharge batteries, or run power directly to requirements. This method is unique from any existing PV systems in that the PV cells which comprise the module are not wired in series, parallel, or series/parallel combination. Further, since maximum power point control is performed for each cell or module, the power unbalance can be minimized.

The wiring improvement solar panel provides control over individual or over line of solar cell/module, thus the solar cells/modules are electrically detachably attached to the solar panels, and consequently, from a circuit stand point, damaged or non-performing unit solar cells/modules can be addressed from the load site.

The wiring improvement solar panel provides an improvement over prior art solar panel employing bypass diode. Bypass diodes are typically built in the solar cell/module and function to effectively electrically remove the solar cell/module out of the solar panel when this particular cell/module power output drops below the operating voltage. In contrast, the present invention has control over each solar cell/module or a line of solar cell/module to determine the contribution of the particular cell/module. Thus in the partially shaded condition, the solar cell/module output power is still contribute to the solar panel, since the output voltage or current of the solar cell/module can be controlled, for example, boosted to the operating condition of the solar panel.

The wiring improvement solar panel can also comprise a solar panel in which each solar cells/modules are connected singly to a maximum power point tracking circuit located on an efficiency improvement board, or a plurality of solar cells/modules are connected linely to a maximum power point tracking circuit located on an efficiency improvement board.

Under reduced incident solar radiation, the solar cell array does not receive enough sunlight to produce adequate power to charge the battery or to power a load, and therefore the solar cell array is inactive and the power generated by the solar panel is lost. Since the current produced by these photovoltaic cell arrays is constant, in the best of lighting condition, the photovoltaic array loses efficiency due to the fixed voltage of the battery. For example, a photovoltaic array rated 75 W, 17 V will have a maximum current of 75/17=4.41 A. During direct sunlight, the photovoltaic array produces 17 V and 4.41 A, but since the battery is rated at 12V, the power transferred is only 12*4.41=52.94 W, for a loss of about 30%. This is a significant power loss; however, it is not desirable to reduce the maximum possible voltage provided by the photovoltaic array because in the reduced sunlight condition, the current and voltage produced by the photovoltaic array will drop due to low electron generation, and thus might not able to charge the battery.

In order to improve the efficiency of the photovoltaic array, a method of Maximum Power Point Tracking (MPPT) is introduced where the voltage provided by the photovoltaic array is tracked and converted to the battery voltage by a DC-to-DC converter before the power is supplied to the battery. This MPPT method can recover the 30% power loss, provided that the power consumed by the MPPT circuitry is not excessive. In the example of the photovoltaic array of 75 W, 17 V (4.41 A maximum) above, a MPPT circuit would comprise a DC to DC converter that reduces the voltage output to 13 V. Since the DC to DC converter conserves the power, the 17 V, 4.41 A power would be conserved, and thus the output of the DC to DC circuit would be 13 V, 5.77 A (conservation of power=17 V×4.41 A=13 V×5.77 A). With the DC to DC converter of the MPPT circuit, the current produced is higher than the maximum current of the solar panel. The reason for the use of 13 V is to provide a positive voltage difference between the output of the MPPT circuit and the battery.

MPPT circuit can address the challenge of PV devices that the PV power generated varies significantly based on both the exposure to sunlight and the load applied to the device. A maximum current can be achieved with a short circuited load, but under this condition, the output power generated by the PV device is zero. On the other hand, if the load has a maximum voltage, the current from the PV device drops to zero, and also no power is generated. Therefore, the output load has to be adjusted based on the exposure level of the panel to sunlight to yield maximum power. A switch mode power conversion to dynamically modify the load based on the available power generated by the PV device can achieve an operational point defined as Maximum Possible Power Generated (MPPG).

However, MPPT circuit normally employs an increase in PV voltage, and then dynamically adjusts the output voltage to ensure maximum power conversion. MPPT circuit is thus expensive but necessary to optimize the power that a solar panel can deliver.

In PV systems, energy cannot be generated if the potential generated by the cells is not greater than that of the battery potential, even with the use of conventional MPPT circuit. This condition often exists during low exposure levels and high angles of incidence to the sun. Thus together with MPPT technique, various methods and circuits have been developed to improve the efficiency and applications of solar cell array. For example, if a supply of 5V is needed from a low voltage solar cell of 3 W (1 V, 3 A), a voltage booster circuit is required to bring the solar cell voltage to 5 V to operate the load. For example, a solar system can use a DC/AC converter to convert a DC power received from the solar panel into an AC power, or a DC/DC converter to convert into an arbitrary DC voltage.

The wiring improvement solar panel can also comprise a solar panel in which each solar cells/modules are connected singly to a voltage or current booster circuit located on an efficiency improvement board, or a plurality of solar cells/modules are connected linely to a voltage or current booster circuit located on an efficiency improvement board.

The booster circuit of the present invention is designed to capture the power generated from the solar panel that would have been lost under low light conditions. The basic concept of the booster circuit is to increase the output voltage to ensure adequate battery charging.

The booster circuit can further comprise a voltage booster circuit and a MPPT circuit to maximize the solar efficiency. By boosting the output voltage of the solar panel to a higher voltage, the MPPT circuit can work efficiently and the solar panel can produce power under reduced sunlight conditions. The basic MPPT circuit comprises a DC to DC converter that normally only reduces the voltage output to optimize the power output. There are two kinds of DC to DC converter, a step-up DC to DC converter (called a booster circuit), and a step-down DC to DC converter (called a buck circuit), and the two circuits are not normally mixed. Thus normally the MPPT circuit only comprises a step-down DC to DC converter. A MPPT circuit that comprises a mixture of converters, meaning can step-up as well as step-down is very expensive and not very power efficient.

A step-down MPPT circuit works well during high sun power where the solar panel output voltage is high. However, during low sun, cloudy conditions or high angle sun, the solar panel might not produce enough voltage. And the MPPT circuit does not help in these conditions.

The booster circuit preferably comprises a voltage booster circuit such as a step-up voltage circuit to generate higher voltage. The booster circuit also is preferably designed to operate at all power levels of the solar cell array, providing the booster function at low power level during the low power period of the solar cell array, and preventing component failure at high power level during the normal operation of the solar cell array. The booster circuit can further comprise a circuit breaker to prevent damage to the power extractor circuit at high power. Furthermore, many booster circuits can also be installed in series to cover a wide range of power level of the solar cell array.

Recently, the use of electric and electronic devices has grown rapidly, especially portable and mobile devices. Adequate power supply such as portable battery pack remains one of the big challenges with the continuing development of portable electric and electronic devices. Though there are somewhat standardized power and battery connectors and sizes, there are still many variations, for example, battery connectors are different for commercial 9V, 1.5 V of A, AA, AAA, B, C or D sizes, for military BA5590, BB2590, or MBITR.

The result of these variations is the inconvenience and high cost for most customers. With these differences in the socket structures, there exists a plurality of connector or converter products. Also, with different types of battery such as Li ion, NiCd, or NiMH, optimum charging conditions vary and thus the electronic controller charger is different for different type of battery.

Further, the half-spent batteries cause a minor problem of requiring frequent battery change, but are too useful to be discarded, or too far away from an outlet to fill them up.

The portable solar panel can comprise a battery multi-interface unit, which comprises an electronic controller device which has a plurality of battery interface capabilities, plus computer interface such as USB ports and interfaces for various AC/DC voltage and current conversions and outlets, and interfaces for solar, wind, generator, vehicle, or other energy sources. The controller devices further comprise circuits for charging battery, for transferring power from one battery to another, and for operating equipment and electric and electronic devices. The battery multi-interface unit can further comprise various inputs and output switches for functionality selection, and various indicators. The battery interfaces of the battery multi-interface unit comprise cradles for AAA/AA, C, and D batteries, 9V batteries, military batteries including BA5590, BB2590, MBITR, etc., and other battery types such as 6V, 12V or 24V batteries. Other interfaces include two or three prong 110 and 220 VAC, 6/12/24 VDC outlets or plugs, terminal posts for bare wire connections, locking and non-locking cable connectors for power inputs, USB ports, and interfaces for electric current or voltage inputs from solar, wind, generator, or vehicle.

The multiple interfaces of the battery multi-interface unit can be optionally separated into input and output sections. The interfaces can be permanently separated into input and output, meaning a battery connected to the input connectors can only provide the power to the battery multi-interface unit, and a battery connected to the output connectors can only receive power from the battery multi-interface unit. The interfaces can be controlled by various switches that can set different interfaces to be input or output depending on the user's selection. The interfaces can also be automatically controlled according to certain algorithm, so that there is no need for manually setting switches.

The operation of the battery multi-interface unit comprises the conventional battery charging by AC outlet. In this configuration, one interface input of the battery multi-interface unit is connected to an AC outlet, either 110VAC or 220VAC. The other interface output of the battery multi-interface unit is connected to a battery. The circuit of the battery multi-interface unit comprises a voltage step down and a rectifier to convert the AC voltage to the battery voltage. The circuit can optionally comprise a conditioner circuit to ensure optimum charging for different types of battery. Variations of this configuration include the input to be power generator such as solar power, wind power, portable generator, car battery, or computer power source by a USB cable. Examples of this configuration include the recharging AAA/AA, C or D or 9V batteries from 110VAC, 12/24vDC outlets or a solar panel array/wind generator. The battery multi-interface unit further enables the simultaneously charging a multiple batteries at a same time.

The function of the battery multi-interface unit also comprises the power transfer from one battery to another. In this configuration, a full, or partially full, battery is connected to an interface input of the battery multi-interface unit, and a rechargeable battery, which is empty partially full, is connected to an interface output. The battery multi-interface unit can transfer the energy from the input battery to the output battery, even if the batteries are not the same battery types and battery voltages. This functionality allows the recovering of unused energy from partially used batteries and combining this energy into one battery. The circuit of the battery multi-interface unit comprises a step down converter in the event that the input battery voltage is higher than the output battery voltage, and comprises a step up converter in the event that the input battery voltage is lower than the output battery voltage. The circuit can also comprise a charge pump to push the last bit of energy from the input battery to the output battery. An example of this configuration setup would include two connectors for the military BA5590/BB2590 batteries to allow the transfer of energy from one to the other. The battery multi-interface unit further enable the simultaneously energy transfer from multiple input batteries to one output battery, from one input battery to multiple output batteries, or from multiple input batteries to multiple output batteries.

The functionality of the battery multi-interface unit can also comprise the capability of running various equipment and devices with power sources having different voltage and current specifications. In this configuration, a power source is connected to an interface input and a device or equipment is connected to an interface output. The power source passes through the battery multi-interface unit and powers the device or equipment. The battery multi-interface unit changes the power properties of the input sources to meet the power requirements of the device or equipment. For example, a battery can be connected to the input and a device requiring 120VAC is connected to the output. The battery multi-interface unit then converts the battery DC voltage to 120VAC to power the device. Another example is a 6VDC battery is used to power 24VDC equipment, with the battery multi-interface unit converting the 6V to the 24V needed. The battery multi-interface unit further comprises current combination capability so that multiple power sources can combine their current together to power the equipment. Also the battery multi-interface unit can simultaneously run on multiple power sources and multiple loads. The circuit of the battery multi-interface unit then comprises step-up, step-down converter, DC to DC converter, DC to AC converter, AC to DC converter with current and voltage regulators and conditioners.

The size of the unit will vary depending upon number and type of battery cradles and interfaces, and power input/output plugs. For the military battery example cited above, it would be approximately 6″×3″×3″.

One possible interface of the battery multi-interface unit is an USB port. Recently, USB ports have become standard specification for personal computers. Typically, the USB (Universal Serial Bus) port includes a pair of data ports for data transmission and a pair of power ports for connection to a power supply. The USB data ports is for controlling the USB device, and the power port of USB cable can provide portable power, and the battery multi-interface unit can comprise an interface accommodating USB port for accessing the power from a computer through a peripheral using a USB port. The USB power ports can be connected to a step-up or step-down and a regulator to provide the necessary voltage. The regulator converts the input from the power connection, which is typically 4.5 to 5 V to the usable voltage and then supplies the voltage to an output interfaces on the battery multi-interface unit.

The battery multi-interface unit can accommodate various battery types. Batteries can be different types, such as lithium-ion (Li-ion), nickel metal hydride (Ni—MH), or nickel cadmium (Ni—Cd). Different type of batteries has different level of charging voltage and charging method, thus, appropriate charging conditions and methods must be applied according to the type of battery. Thus the battery multi-interface unit preferably includes a control portion to differentiate between different types of battery to charge the selected battery appropriately. The control portion can include charge control signals such as a charge start/end signal to enable output of the charging, a charge voltage signal, a battery type signal to control the output voltage level, a battery selection signal, a charge current/voltage control signal, and a reset signal. The control portion controls the charging according to the type of battery.

The control portion preferably includes at least one analog-to-digital converter (ADC) to process analog charge voltage and current from the battery. The control portion preferably includes various I/O ports corresponding to various control signals, plus a pulse with modulation and digital-to-analog converter (PWM/DAC) to process the charging mechanism appropriately to different type of battery.

Advantageously, the battery multi-interface unit of the present invention provides a user with more power source flexibility than before. In its best function, the present invention can allow any power source to power any devices, regardless of voltage or current requirements. The present invention also provides a means to accumulate power from half full batteries.

In some embodiments, the present invention is connected to an external power source to power the battery multi-interface unit. The external energy source can be an AC energy source such as a conventional AC electrical outlet. In such configuration, the battery multi-interface unit can comprise a power converter, which is typically an AC-DC converter that converts an AC input voltage and current into a DC output voltage and a DC output current. For example, the AC-DC converter may comprise a transformer and a rectifier. The transformer converts the input AC voltage to another AC voltage, which is then transformed or rectified by the rectifier into the DC output voltage. The AC-DC converter may further comprise a regulator portion or circuit. The regulator circuit regulates the DC output voltage and the DC output current. For example, the AC-DC converter may convert an AC input voltage of 120VAC into a regulated DC output voltage of 5VDC.

In other embodiments, the battery multi-interface unit is connected to an external energy source which is a DC energy source including a battery in an automobile. For example, many automobiles have direct access to the car battery (e.g. cigarette lighters) that functions as a 12 VDC power source. In such configurations, the power converter of the battery multi-interface unit is a DC to DC converter that converts a DC input voltage and current into another DC output voltage and current. The DC to DC converter may further comprise a regulator that regulates the DC output voltage and/or a DC output current.

The battery multi-interface unit optionally comprises power conditioning circuits. The power conditioning circuits is any device or circuit that conditions a voltage and/or a current, such that the voltage and/or current are made suitable for charging the output battery. The power conditioner can be a DC to DC converter that converts a voltage into another voltage that is better suited for charging the battery. The DC to DC converter may be any of the various DC to DC converters such as linear regulators, switching regulators and converters, and charge pump converters.

The connectors of the battery multi-interface unit can be adapted to make electrically contacts on a surface of the device, such as pressure contacts, friction contacts, mechanical contacts or other means of contacting such as mating male/female connectors. The battery multi-interface unit may also include various indicator lights, such as a light emitting diode (LED) or other indicator. The indicators can indicate the interface functionality (such as input or output), the voltages and currents of the input, the amount of charges in the battery.

The present invention further comprises a method to charge battery, to transfer energy or to operate a device using the battery multi-interface unit. The present invention provides an interface unit between a power source and a device so that any power source can be used to power any device. The present invention provides an advanced and multi-purpose operation unit featuring the use of multi-interface connectors to provide power to a battery or to power a load.

What is claimed is:

1. A portable solar panel comprising
a plurality of solar cells on the surface of the solar panel; and
a plurality of attachment points on the perimeter of the solar panel;
wherein the attachment points allows the use of strap or strap attachments for quick attachment and detachment of the portable solar panel to an object while maintaining good portability.

2. A portable solar panel as in claim 1 wherein the attachment points comprise grommets, webbings, ropes, wire loops, chain loops, grab lines, buttons, suspender buttons, or ring devices of D, O, square, rectangular or loop.

3. A portable solar panel as in claim 1 further comprising a plurality of straps or strap attachments for attachment and detachment of the portable solar panel to an object.

4. A portable solar panel as in claim 1 wherein the straps or strap attachments comprise adjustment devices for adjusting the length or tightness of the strap.

5. A portable solar panel as in claim 1 wherein the portable solar panel is a tarp or fabric-style or plastic-style solar array.

6. A portable solar panel as in claim 1 wherein the solar panel comprises a wiring improvement of individual solar cell or lines of solar cells connection.

7. A portable solar panel as in claim 1 further comprising a strap attachment for the attachment of the solar panel to a backside or to a side of a backpack.

8. A portable solar panel as in claim 1 further comprising a strap attachment for the attachment of the solar panel to a hood, a roof, trunk, front, side or back of a vehicle.

9. A portable solar panel as in claim 1 further comprising a strap attachment for the attachment of the solar panel to a tent or a portable structure.

10. A portable solar panel as in claim 1 further comprising a multi-interface unit for battery connection.

11. An improvement for a solar panel wherein the improvement comprises a plurality of attachment points on the perimeter of the solar panel, wherein the attachment points allows the use of strap or strap attachments for quick attachment and detachment of the portable solar panel to an object while maintaining good portability.

12. An improvement as in claim 11 wherein the attachment points comprise grommets, webbings, ropes, wire loops, chain loops, grab lines, buttons, suspender buttons, or ring devices of D, O, square, rectangular or loop.

13. An improvement as in claim 11 further comprising a plurality of straps or strap attachments for attachment and detachment of the portable solar panel to an object.

14. An improvement as in claim 11 wherein the solar panel comprises a wiring improvement of individual solar cell or lines of solar cells connection.

15. An improvement as in claim 11 further comprising a multi-interface unit for battery connection.

16. A field portable solar battery charger for transportably charging battery using polar power, comprising
a portable solar panel comprising a plurality of solar cells;
a plurality of attachment points on the perimeter of the solar panel; and
a plurality of straps or strap attachments;
wherein the attachment points allows the use of strap or strap attachments for quick attachment and detachment of the portable solar panel to an object while maintaining good portability.

17. A portable solar panel as in claim 16 wherein the attachment points comprise grommets, webbings, ropes, wire loops, chain loops, grab lines, buttons, suspender buttons, or ring devices of D, O, square, rectangular or loop.

18. A portable solar panel as in claim 16 wherein the straps or strap attachments comprise adjustment devices for adjusting the length or tightness of the strap.

19. A portable solar panel as in claim 16 wherein the solar panel comprises a wiring improvement of individual solar cell or lines of solar cells connection.

20. A portable solar panel as in claim 16 further comprising a multi-interface unit for battery connection.
